(19) United States
(12) Patent Application Publication
(10) Pub. No.: US 2018/0353970 A1
(43) Pub. Date: Dec. 13, 2018

(54) Electric Solid-liquid Separator Using Insulated Metal Beads

(71) Applicant: LaBaer, San Diego, CA (US)

(72) Inventors: Ying Bai, San Diego, CA (US); Hui Vicki Tan, San Diego, CA (US); Xu Chen, San Diego, CA (US); Ao Chen, San Diego, CA (US)

(21) Appl. No.: 15/616,794

(22) Filed: Jun. 7, 2017

(51) Int. Cl. B03C 5/00; B03C 5/02

(52) U.S. Cl. CPC B03C 5/005; B03C 5/026

(57) ABSTRACT

Insulated metal beads forming a bead bed are used in an electric separator to separate solid particles from a liquid. The electric separator has a separator vessel having a fluid ingress at a first side and a fluid egress at a second side, an electrode electrically connected to a power source and contained within the vessel, along a central axis, and a plurality of high permittivity beads arranged as a bead bed within the vessel positioned around the electrode. The electrode has a first polarity and the vessel has a second polarity such that an electromagnetic field is generated by either DC or AC voltages between the electrode and the vessel. A separation cycle for separating the solid particles from the liquid can be accomplished by 1) powering up an electrode within the vessel such that the electrode and the vessel have an opposite polarity, the liquid and the beads forming a medium having a high permittivity and 2) passing the fluid through channels between the beads, the solid particles within the fluid being retained against the beads as a consequence of the electric force induced by the electrical field(s).

### BACKGROUND OF THE INVENTION

### 1. Field of Invention

The present invention relates to an innovative apparatus and method used in the field of the particulate matter separation from liquids, in particular, electric separation with both Dielectrophoretic and electrophoretic forces from liquids having high electrical resistivity such as oil.

### 2. Description of Related Art

Removing micron or submicron particles from a heavy oil stream remains an industry wide challenge. One of many challenging examples is the spent catalyst fines removal from Fluid Catalyst Cracking (FCC) slurry oil or decant oil. Fluid Catalyst Cracking (FCC) process in a petroleum refinery is widely used to convert the high-boiling, high-molecular weight hydrocarbon fractions of petroleum crude oils to smaller chains comprising more valuable gasoline, olefinic gases, and other products. The most commonly used FCC catalyst is a solid sand-like fine powder formed of alumina-silicate base particles. After FCC, a small percentage (2%-9%) of the long-chain hydrocarbon feedstock oil remains unbroken at the bottom of the FCC unit, which is called FCC slurry oil or decant oil. This FCC residual oil or slurry oil contains a high concentration of FCC catalyst in the range of approximately 1000 ppm to 10,000 ppm. The removal of catalyst from slurry oil can increase the heavy oil grade level and value.

A number of electrical theory-based apparatus or methods had been considered for removing catalyst from slurry oil. Electrofilter or electrostatic separation has been widely used in petroleum refinery procedures due to high removal efficiency. Examples of these types of electrostatic separators are described in U.S. Pat. No. 3,928,158 and U.S. Pat. No. 5,308,586 to Fritsche et al., and are referred as electrostatic glass bead-containing bed separators. In use, electrostatic bead bed separators employ a central electrode and a cylindrical electrode within a hollow cylindrical vessel, with a volume of glass beads packed into a hollow container as a glass bead bed. A high-voltage gradient is provided across the bead bed between the central electrode and the cylindrical vessel. As U.S. Pat. No. 3,928,158 describes, to be effective in removing particulate contaminants, the beads used must have higher electrical resistivity than the liquid to be filtered. Therefore, glass beads, specifically soda-lime glass beads, may be used. Comparing to soda-lime glass beads which contain sodium oxide, U.S. Pat. No. 5,308,586 to Fritsche et al. replaces soda-lime beads with potassium glass beads. Potassium glass beads also have high resistivity, and the removal efficiency by using potassium glass beads as components of the bead bed in the electrostatic separator has been shown to result in improved performance in particulate contaminant removal over that using soda-lime glass beads as constituents of the bead bed. The catalyst and other contaminating particles are captured surrounding the bead surface as the oil passes through the interstitial spaces between the glass beads, and the result is a purer slurry.

Electric separation forces on charge-natural particles in liquid are mainly contributed by Dielectrophoresis and Electrophoresis theories. Electrophoretic forces have been neglected since there are mainly applicable to the charged particles, and only occur under some special conditions. One plausible theory explaining electric separation forces is Dielectrophoresis or “DEP” was first adopted in 1950s by Pohl for the unique electromechanics of particles suspended in a fluid medium when exposed to an applied electric field gradient. In a uniform electric field, the field-induced force on charge-neutral particles is zero or infinitesimal small. Real world electric fields are typically non-uniform in that electric field lines are non-parallel and/or non-evenly spaced. The electric field line spacing, ranging, possibly, from sparse to dense, being reflective of field strength (the denser the spacing, the stronger the field strength) while the non-parallel electric field lines reflect the fact that the electric field does not lie between two parallel plates of infinite length (a pre-condition for a truly uniform electric field—something which exists only in theory. The non-uniform electric field polarizes the dielectric particles. The net forces on the polarized dielectric particles are called “dielectrophoretic forces” (DEP forces). Further, the electric field produces a voltage potential gradient, between the particles and the fluid medium. A formula can be derived and quantified in terms of the effective electromagnetic dipole force on the polarized particles induced by the applied electrostatic field. For example, for the simple case of a spherical particle of radius R and permittivity εₚ immersed in a lossless dielectric fluid of permittivity εₘ and subject a non-uniform electric field E:

F_{DEP}=2πR³_{ε}_{ₘ}_{κ}(∇E²), (1)

where k is (εₚ−εₘ)/(εₚ+2εₘ), the real part of Clasius-Mossotti facto represents the effective polarizability of the particle with respect to the liquid medium. The (∇²) term quantifies the electric field strength and gradient. F_{DEP} is the DEP force. Equation (1) indicates that DEP force is proportional to the volume or size of the particle, and the strength and gradient of the applied electric field E. Accordingly, DEP filtration systems can be designed and improved by designing an effective gradient and strength region for the applied electric field.

Dielectrophoretic separation employs dielectrophoretic force under the non-uniform electric field to remove solid contaminants. However, there have been problems applying DEP principles to resolve the industrial solid-liquid separation or filtration issues, particularly the spent catalyst removal issue from FCC slurry oil. Because in the industrial apparatus's setup, the dielectrophoretic force acting on the particle is much smaller than the gravitational force (depending on the particle's weight), DEP is mostly employed in trapping or separating lighter particles, such as blood cells and cancer cells, in biological or biomedical applications. In these applications, DEP forces, approximately 10 times stronger than a gravitational settling force, can be created by applying micro-electromechanical structural electrodes under normal tens (10s) VDC or VAC. And in last decade, numerous technical publications and hundreds of patents in biomedical application employed dielectrophoretic separation.

In order to apply DEP in large-scale industrial applications, such as removing tons of spent catalyst from thousands of tons of the refining process oil streams, slurry oil in particular, stronger DEP forces on the particulates must be created to achieve practical efficiency and processing capacities. A dielectrophoretic force will be induced and result in a separation motion between the particles and the medium, once the permittivity εₚ of the particle is significantly differentiated from the permittivity of the medium εₘ. In these cases, the magnitudes of dielectrophoretic forces are proportional to both the applied electric field and the resulting electric field gradient.

Therefore, there is a need for a device using a medium with a high permittivity εₘ and a particular arrangement to induce a non-uniform electric field to produce an electric field gradient generating stronger DEP forces in a consistent manner to facilitate solid-liquid separation in oil applications, particularly slurry oil.

### SUMMARY OF THE INVENTION

An electric apparatus is disclosed which features an electric solid-liquid separator using insulated metal beads. The insulated metal beads in electric fields will further maximize non-uniformity of the applied electric fields. In turn, Dielectrophoretic forces applied on the dielectric particles are maximized through the electric fields with the coated metal beads. Although the apparatus of this invention employs a bead bed separator, inside this separator, dielectrophoretic forces are applied to separate solids from the liquid instead of the electrostatic forces as disclosed in the prior art. An electrode positioned within or near a vessel provides a non-uniform electric field, which induces the DEP forces in a bead bed within the vessel. Since metal presents a medium with high permittivity, metal beads employed as a separator present a higher permittivity as compared with a medium using glass beads in an electrostatic bead bed separator. The metal beads may be insulated at the surface to be non-conductive in the liquid, and these insulated metal beads can be highly polarized in the cylindrical electric field, wherein the interstitial spaces among the insulated metal beads can induce the strongest gradient of electrical field. Therefore, based on Equation (1), the stronger DEP forces can be generated to act on the particles when the liquid passes through the interstitial spaces in the insulated metal beads bed.

One embodiment includes a chamber of a vessel that is preferably a cylindrical vessel and has at least one inlet and one outlet. In some embodiments, the vessel serves as a ground electrode, and an electrically connected high voltage electrode preferably located at the center thereof, having insulation blocks for the high voltage electrode to feed through the shielding vessel. The ground and electrode may be positioned on either side of the bead beds, however, in any configuration that provides an electromagnetic field across the bead bed. Compared to the electrostatic glass bead-containing separator, the insulated metal beads of the present invention are employed as the bead bed instead of glass beads. The apparatus also includes a pair of insulation disks at the inlet and outlet of the separator with evenly-distributed apertures that allow the liquid to flow through the separation electrical field evenly. The diameters of the vessel, central rods, and insulated metal beads are selected based on mathematical models and practical considerations such as space for the separator, to allow the densely-packed metal beads to minimize the interstitial spaces among the beads and maximize the relative gradient of field within those spaces. The interstitial spaces among the densely-packed metal beads create narrow paths for liquid to flow through. Once the central electrode is energized by high-voltage DC or AC power, the particles in the liquid experience the significant DEP forces that induce a separation motion perpendicular to the flow direction. The particles with the separation movement are retained and collected within the intersections among the metal beads and the surface of the metal beads. The application of high permittivity mediums (typically containing metal), as provided by the densely packed insulated metal bead bed of the embodiments, are key measures toward maximizing DEP forces and maximizing particulate separation.

In general, an electric separator is disclosed with DEP force as one of main separation forces that includes densely packed, high permittivity (metal) beads around a central metal electrode encompassed by a cylindrical metal shell. Different geometric shapes of the bead can be applied to achieve the particle separation effect. Considering the manufacturability and lifetime of the insulation layer on the surfaces of the metal beads, the sphere or circular shape for the beads are preferred and selected. Given the cylindrical shell as the boundary, several diameter sizes of the metal beads can be selected to achieve more dense packing to maximize DEP forces and separation efficiencies, over the DEP forces of uniform beads. In an embodiment, it is advantageous to pack beads with different diameters in the cylindrical vessel so as to minimize the interstitial spaces among the beads. In another embodiment, the beads are all uniform in diameter.

The apparatus may include an inlet manifold disk through which fluid can be evenly distributed to the insulated metal beads bed. The apparatus may also include an outlet manifold disk through which fluid can be removed from the substrate. The inlet and outlet manifold may be made of insulation materials, such as Polytetrafluoroethylene (PTFE), that provide electrical isolation for the insulated metal beads from the end lids of the cylindrical vessel. When the central electrode is powered by high voltage, the apparatus begins separating particles from fluids due to DEP forces, in particular, at the intersections of the beads. The operational duration of the separating process can be estimated by considering the particle collection volume of the total interstitial spaces, the incoming particle concentration in the liquid, the separation efficiency and the liquid flow rate. This duration can be actively controlled by regulating the specified pressure drop threshold between the inlet and the outlet. During the cleaning process, the DEP separator is electrically disconnected, and/or the central high voltage electrode is disconnected. Without DEP forces to retain the particles, the collected particles are freed and may easily be removed by a backwash, namely flowing an aqueous liquid in a reverse direction, upwardly through the insulated metal beads bed if the bead bed is vertically oriented. This has significant advantages over the troublesome mechanical filter cleaning described in the prior art.

It is necessary to determine appropriate interval durations of separation/cleaning cycles to maximize the benefits from DEP separator, depending on the intended use. If the separation cycle goes on too long without cleaning, the separator can become clogged, however cleaning too frequently is unnecessary and reduces efficiency of the separation as it consumes time and backwash materials. In general, there are two methods to find out the appropriate periods or duration and frequency of the separation and clean cycles: i) a static or fixed duration for operating separation cycles and cleaning cycles, and ii) dynamic feedback control on the separation and cleaning cycles. Once the particle concentration in the liquid is steady or varying within a predetermined range, the static method may be employed by operating the separation cycle repeatedly in a constant period. In an embodiment, the separation period interval Ts can be simply estimated by the channel capacity W of the separator, fluid rate f, and the particle concentration λ using the following formula:

Ts=W÷(f×λ)

In general, the cleaning period Tc is short and pre-defined due to the high voltage power source being off and channel surface smoothness. The operation cycle period combines both Ts and Tc. The second method is a dynamic method wherein a feedback loop is used to determine the amount of pressure required or oil throughput, wherein a substantial reduction in either results in an automated cleaning cycle being engaged. The dynamic method is more directed towards industrial automated application of the system to target for different levels of concentration of particulates in the fluid. In industrial environments, automated operation procedures are programmed to alternate between separations and cleaning operations.

In another aspect, the invention features a filtration system for filtering fine particulates from the liquid comprising the DEP separation apparatus of the foregoing aspects and supply reservoirs, wherein the supply reservoirs are respectively configured to supply and collect liquid from the separator using DEP force. The system can include a pre-filter configured to filter liquid from the reservoir prior to the liquid being supplied to the apparatus. The pre-filter can substantially prevent certain particles in the liquid, such as those larger than a threshold particle size (e.g., the threshold particle size can have a maximum dimension equal or bigger than the width of the interstitial spaces that formed by the adjacent beads), from entering the apparatus.

In general, in another aspect, the invention features a system for filtering a fluid, including a supply reservoir, the insulated metal or high permittivity beads bed fill the space between a central electrode and a vessel shell electrode, a collection reservoir, and a high voltage DC power supply for up to 10 kV. During operation of the system, the supply reservoir supplies the fluid to the interstitial spaces among the beads and the collection reservoir collects fluid exiting from the beads bed, and the high voltage power applies a needed voltage potential on the central electrode to create the gradient electric field.

The electric separator may comprise a vessel with the ingress and egress. In an embodiment, a cylindrical vessel is used, and the ingress and egress are located at opposite ends.

In an embodiment, the insulated metal beads used in the electric separator may be coated with the insulation materials, selected from the group consisting of PTFE plastic and ceramic. Due to the DEP forces, the particles may be retained against or near points of contact among the beads.

The electric separator may have an inlet manifold disk between the fluid ingress and the beads bed, and an outlet manifold disk between the beads bed and the fluid egress, for evenly distributing the fluid flow. The inlet manifold disk and outlet manifold disk may be made from a material selected from the group consisting of ceramic and PTFE.

The electric separator may also have a pre-filter on the fluid ingress to filter large-sized particles before fluid enters the vessel.

A method of performing a separation cycle has the steps of: i) powering up an electrode within a vessel such that the electrode and vessel have an opposite polarity, creating a gradient field across an insulated metal or high permittivity beads bed contained within the vessel, ii) passing the fluid through the beads bed, and iii) retaining the solid particles within the fluid against the intersections of beads by electrical field(s).

The method may have the additional steps of: i) powering down the electrode within the vessel to cease generation of the electromagnetic field, ii) feeding a cleaning fluid into the vessel, and iii) passing the cleaning fluid through the beads bed and pushing the particles out of the beads bed, wherein the particles are no longer retained against the beads by an electromagnetic field.

In an embodiment, the cleaning fluid enters the vessel from the egress end and exits from the ingress end. The method may have the additional step of pushing pressurized gas through the vessel from either of the ingress or egress ends, to push out the cleaning fluid.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a diagram of an electrical solid-liquid filtration system using Dielectrophoresis (DEP), according to an embodiment of the present invention;

FIG. 2A is a schematic diagram of a electric separator, according to an embodiment of the present invention;

FIG. 2B is an isometric cut-away view of the separator, according to an embodiment of the present invention;

FIG. 2C is an elevation cut-away view of the separator, according to an embodiment of the present invention; and

FIG. 3 is an elevation cut-away view of the insulated metal beads, according to an embodiment of the present invention.

### DETAILED DESCRIPTION OF PREFERRED EMBODIMENTS

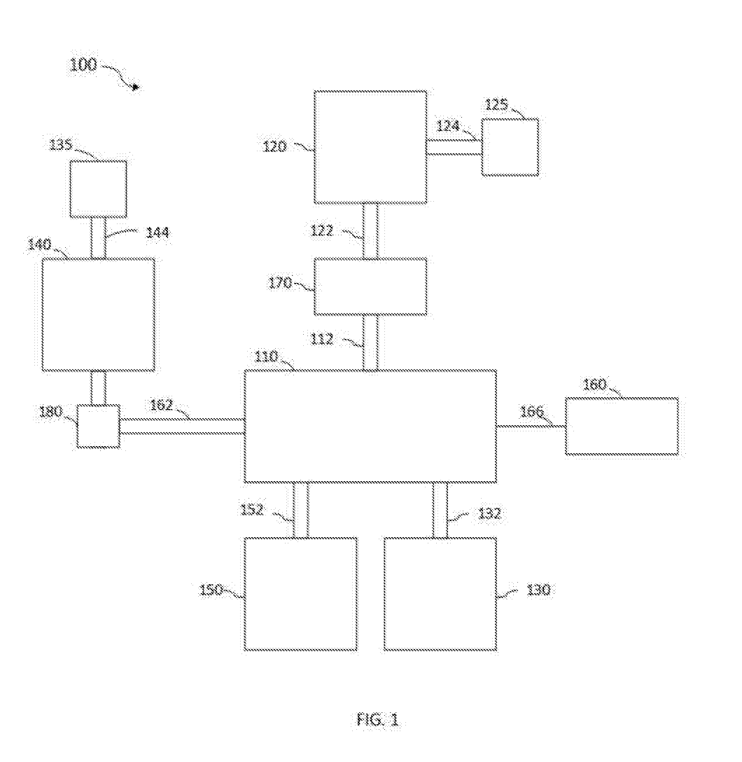

Preferred embodiments of the present invention and their advantages may be understood by referring to FIGS. 1-3, wherein like reference numerals refer to like elements.

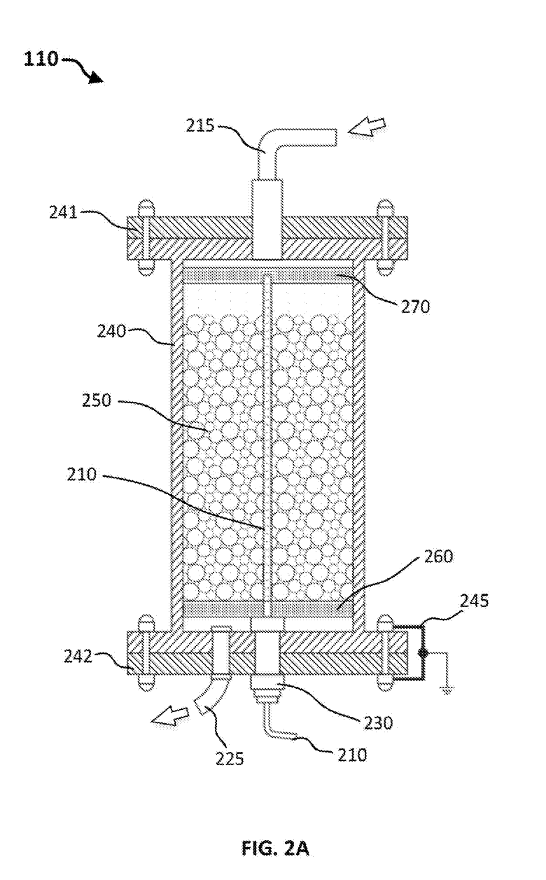

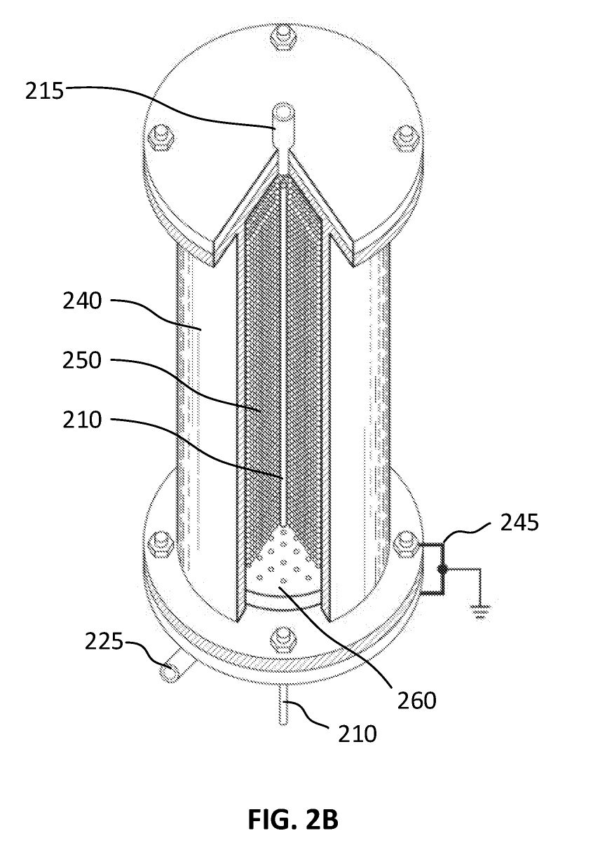

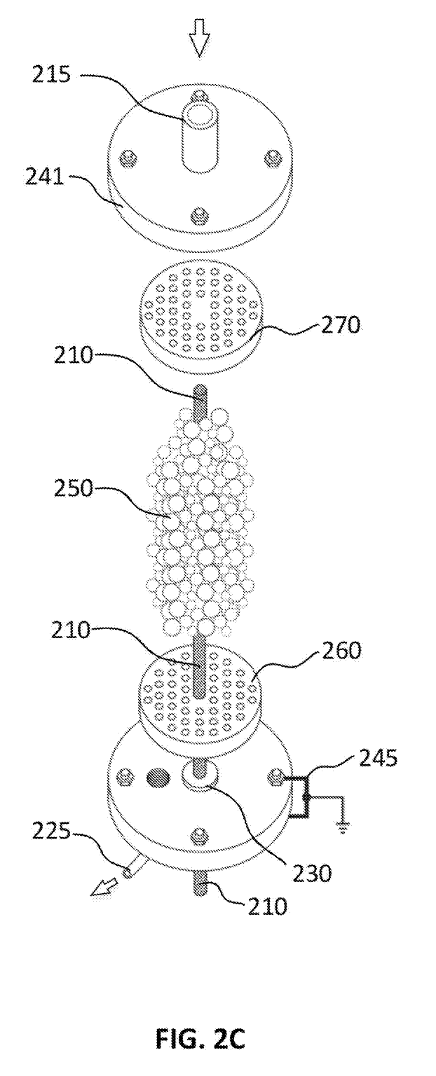

In industrial applications, such as crude oil refineries, there are two major process cycles to operate the filtration systems: particle separation and cleaning. Referring to FIG. 1, an embodiment of an electrical filtration system 100 according to the present invention comprises an electrically insulated metal bead-filled bed separator 110 (shown in detail in FIG. 2A, 2B and 2C and including electrically insulated metal beads), supply reservoirs 120 and 140, collection reservoirs 130 and 150, high voltage power supply 160, a pre-filter 170. Supply reservoir 120, collection reservoirs 130, high voltage power supply 160 and pre-filter 170 work during particle separation process, and supply reservoir 140 and collection reservoir 150 are used in the cleaning process.

During particle separation, pump 125 delivers liquid (for example, high-particle slurry oil) from supply reservoir 120 to metal bead bed separator 110 through supply pipe 122 and pre-filter 170 that filters large particles out of the liquid before the liquid enters the separator 110 and supply pipe 112. Once the fluid is in the separator 110, in order to separate particles from the fluid, the high voltage power supply 160 applies an electromagnetic field by energizing a high voltage to an electrode within the separator 110 through an electrical connection made by the high voltage cable 166. In some embodiments, the electrode is centrally located with the separator 110. The electrode may be in a position other than the center of the vessel, it is sufficient that the electrode and ground are near or on either side of a bead bed to product a field across the bead bed. In other embodiments, the electrode can assume various shapes within the separator. These include a serpentine shape, oval shape and shapes with several distributed segments. The separator 110 traps and collects the particles from the fluid by means of Dielectrophoresis (“DEP”), and retains particles within the intersections among the metal beads and the surface of the metal beads in the separator 110. The filtered fluid exits separator 110 through the pipe 132 and collects in a clarified liquid reservoir 130. Although FIG. 1 illustrates liquid reservoir 120 being positioned higher than dielectrophoretic separator 110 and collection reservoir 130 and liquid flows downward (in a vertically oriented arrangement), and in preferred industrial embodiments the liquids in the supply reservoir 110 are pumped in from a lower portion or the bottom of a metal bead bed separator 110 such that the fluid is pumped upwards against the gravitational force. This may reduce sedimentation of particles in the system and increase the metal bead bed separator 110 treatment capacity, in certain embodiments.

During system cleaning operation, the high voltage previously applied to separator 110 is turned off, and pipe 112 and pipe 132 connected separately to reservoir 120 and 130 are shut off as well by closing a valve. Without the high voltage, the gradient field is removed and the particles are no longer retained by DEP force against the electrode and the insulated metal beads. Pressurized liquid may be pumped by pump 135 from the supply reservoir 140 to flush the trapped particles out of the separator 110 and into the collection reservoir 150. Once the cleaning operation is completed, the pump 135 is turned off and both collection reservoir 150 and pipe 152 are shut off by closing one or more valves. Once the cleaning or flush cycle is complete, the electrical filtration system is ready to receive more filtered fluid in the particle separation cycle for cleaning.

Referring to FIGS. 2A,-2C, the metal bead bed separator 110 comprises an vessel 240 and an high-voltage electrode 210, wherein the electrode 210 and metallic vessel 240 act as two opposite polarities to create an electric field therebetween, within the body of the vessel 240 and across the bead bed therein. The electrode may also be external to the vessel, so long as a field is produced across the bead bed between the electrode and a ground. A plurality of insulated metal beads form a bead bed 250 surrounding the central electrode, densely filling up the space between the central rod and the shell. Upper mechanical flange 241 and lower mechanical flange 242 (which may be formed of a flange standard such as ASME or other flange systems known in the art) with the shell form the pressurized vessel or chamber to allow the metal bead bed separator 110 to be used for high pressure and high temperature applications that are common processing environments within petrochemical plants or refineries. High voltage feedthrough 230 on a lower flange 242 is applied to the high voltage central electrode 210 from the ground potential carried by the vessel 240 and lower flange 242. A ground wire strip 245 connects the vessel 240 and lower flange 242 to a well-defined ground reference, i.e. electrical ground from an outlet or a building ground. In an alternative embodiment, the vessel may have a voltage and the electrode may be at ground. An inlet pipe 215 is connected on the surface of upper flange 241, while an outlet pipe 225 is connected on the other lower flange 242. Once the incoming fluid passes through inlet 215, fluidic flow is regulated and distributed by an inlet manifold 270 to run through metal bead bed 250 evenly. At the other end, an outlet manifold 260 is positioned to collect the filtered fluid and also provide the needed electrical insulation between the insulated metal beads and lower flange 242. One of key applications of the present disclosure is the filtration of heavy oil streams in crude oil refineries, so for such application both inlet manifold 270 and outlet manifold 260 may be made of high temperature insulating materials like ceramic or PTFE (Teflon®).

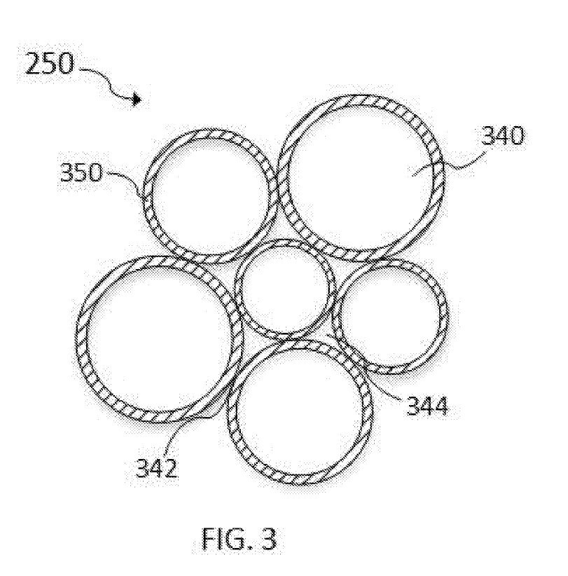

During the separation cycle, fluid pumped from supply reservoir 120 enters the cylindrical vessel through a pipe 215 connected with the flange 241. The fluid flows through, and is distributed by, an inlet manifold 270. The fluid spreads among the insulated metal beads bed 250 and through interstices 344 (shown in FIG. 3) between the beads. The power supply 160 provides high voltage to energize the electrode 210. Between the electrode 210 and vessel 240, a gradient electric field is created that is generally perpendicular to the electrode 210. By filling up the space inside the cylindrical shell 240 with insulated metal beads, localized and stronger electric field gradients are created within interstitial spaces among the metal beads in 250. While flowing through the interstitial spaces in 250, particles in the fluid experience stronger dielectrophoretic separation forces and are attracted to points of contact 342 (shown in FIG. 3) between the beads. Particles achieve a drifting velocity dependent on their size, and the fluid viscosity, and move to the points of contact between the insulated metal beads, where localized maximum or minimum electric fields are created.

In some embodiments, fluid pumped from the supply reservoir 120 enters the vessel 240 through lower pipe 225 on the lower flange 242 and through manifold ports 260. The incoming fluid from the bottom pipe 225 has less gravitational force to overcome for dielectrophoretic separation efficiencies.

During the cleaning cycle, power to the electrode 210 is turned off, which cancels the electromagnetic field. The cleaning fluid in reservoir 140 is pumped through inlet pipe 215 into separator vessel 240. Inlet manifold 270 distributes the incoming pressurized fluid evenly to the metal bead bed 250. The trapped particles in 250 are easily washed out since the trapping forces, DEP forces and polarized particles' attractive forces, are cancelled due to the powering off of the central electrode. At the beginning of the cleaning cycle, the cleaning fluid flows out the outlet manifold with high concentrations of the trapped particles, (in some embodiments up to 20%). After a short interval, the cleaning fluid becomes clarified as the bulk of the particles have already been removed. When this occurs, the cleaning cycle of the metal bead bed separator 110 is completed, and continuation of the cleaning cycle is no longer efficient. The interval of the cleaning cycle can be measured by testing the particle concentration during the wash cycle, or it may simply be timed based on past cleaning events.

In industrial applications, it is economical to use as little fluid as possible to accomplish effective cleaning during the cleaning cycle. One optimization strategy may be to extend the separation cycle as long as possible without degrading the separation efficiency down to a pre-determined threshold i.e. 95%. The duration of the separation cycle is specific for the application and takes into account separation efficiency requirements, the metal beads size, and volume of interstitial spaces among the beads, the temperature, and other factors.

Referring to FIG. 3, in the present embodiment, the insulated metal beads 340 are coated with an exterior layer 350 covering and insulating the metal beads 340. For industrial applications like heavy oil catalyst filtration in crude oil refineries, long-term operation or lifetime of the insulation layer is required. To withstand the abrasive high temperature heavy oil with high-level catalyst concentration, in preferred embodiments for industrial applications, high temperature insulation materials, like Teflon® or ceramic are deposited on the metal beads surface. In general, a ceramic coating has a better performance on abrasion resistance and a higher operational temperature over Teflon® types of high temperature plastic, however the cost of a ceramic coating is higher. Some trade-offs are needed in achieving practical industrial embodiments.

Another embodiment of the invention includes electrically insulated metal bead 340 with a round-shape cross-section of uniform diameter making up the metal bead bed 250. Other cross-sectional shapes may be used to vary the size to minimize the volume of total interstitial spaces among the beads, and in particular, a mixture of smaller and larger diameter beads 340 may provide an optimal combination of smaller interstices 344 and a greater number of points of contact 342. Further, teardrop-shaped or irregular cross-sections may be preferable in certain applications.

The filtration capability of filtration system 100 is dependent on the processing volume of metal bead bed separator 110 and the processing time of the fluid liquid flowing through the separator 110. The processing time can be controlled by the flow rate of the fluid passing through the separator 110. The filtration system 100 can be adapted to filter industrial volumes based on the industrial capabilities and furthermore, the filtration capability can be varied as desired. Parameters governing these characteristics of the separator 110 are discussed in detail below. Although the pre-filter 170 in filtration system 100 is shown as a separate unit, in other embodiments the pre-filter can be included in as a component within separator 110. Alternatively, pre-filtering can be performed in a system separate from system 100, or not at all. Examples of filter types include silicon and ceramic filters with pore sizes designed to exclude certain particles. Silicon and ceramic filters may be advantageous because cross-flow across the surface of the filter can be used to remove the undesirable particles, pore sizes may be uniform and/or high pore densities can be achieved (providing the possibility of high flow rates).

In a preferred embodiment, the vessel 240 is cylindrical. However, the vessel 240 may have other shapes as well in other embodiments, which may be rectangular, hexagonal in cross-section, or a custom shape based on space restrictions.

The plates of inlet port 270 and outlet port 260 are the same size and shape in an embodiment. In general, the size and shape of inlet and/or outlet ports may vary as desired to fit in the vessel for oil distribution. Moreover, the combination of fluidic channels and/or inlet and/or outlet ports can be engineered to provide the desired fluidic flow through the device. In the present embodiment, to give dimensional examples, the inlet plate has small holes drilled in the plate to permit oil to flow into the beads bed, which are formed by a plurality of insulated metal beads. The outlet plate is a same PTFE disk. In an embodiment, small holes of less than 3 mm each were drilled on the outlet plate to allow the oil through the beads bed without the beads to drain out.

Other objects, aspects, features and advantages of the invention will appear from the following description in which the preferred embodiments have been set forth in detail, in conjunction with the accompanying drawings and also from the following claim.

In order to illustrate our invention in detail, reference is now made to the following experiments. Also these experiments were designed to compare the catalyst particulates removal effectiveness out of oil samples between the separator unit filled with glass beads (described in U.S. Pat. No. 3,928,158 and U.S. Pat. No. 5,308,586 to Fritsche et al.) and the unit filled with insulated metal beads.

### Experiment I

In an experiment, a test unit was employed for testing the effectiveness of using insulated metal beads, as compared with glass beads, as the bead bed in the separator 110, a metal cylindrical vessel with a metal rod serving as the central electrode. Two different type of testing beads are filled between the central electrode and vessel. The first beads in the test are regular spherical glass beads. The second type of beads is a high-permittivity and non-conductive beads, such as insulated metal beads. The electric field was monitored by a voltmeter and ammeter. The test unit also has a reservoir of oil above the cylindrical vessel.

A series of tests were conducted in this experiment to compare the particulate separation efficiency for the two types of beads discussed above. The oil samples used in this experiment are a well-mixed test oil with spent fluid catalytic cracking (FCC) catalyst fine. Under the same operating conditions, using the insulated metal beads has more effective than using glass beads. In some experiments, a 99% catalyst particulate removal efficiency was achieved by using insulated metal beads, as compared with 95% removal efficiency using glass beads.

### Experiment II

The following experiment used the slurry oil to repeat the first experiment. The test unit is the same as Experiment I above. The slurry oil sample used in this experiment is from refinery FCC system unit. This experiment still compared the effectiveness of electric separator using glass beads and insulated metal beads as bead bed, respectively. These two types of beads and experimental procedures are the same as Experiment I. During the test, a series of samples were collected at different voltage ratings from the insulated metal bead bed test unit and glass bead bed test unit, respectively.

The original FCC slurry oil sample and all the collected samples were tested for the accurate particulate content by vacuum filtration. The method is the same as the measurement of the Experiment I. For FCC slurry oil samples, under the same input voltage conditions, higher particle removal efficiency was achieved by using insulated metal beads as a bead bed than those by using glass beads as a bead bed. In order to achieve the same particle removal efficiency as the unit with the insulated metal bead bed, the voltage was increased on the electrode of the glass bead bed. By comparison, the voltage needed on the test unit using insulated metal beads is much lower than the using glass beads. Even under the same input voltage conditions, insulated metal beads demonstrated better particle removal efficiency than using glass beads.

Combined with the result from Experiment I, it may be concluded that better removal efficiency in catalyst particle separation can be achieved by using insulated metal beads to form the bead bed in the electrical solid-liquid separator than using glass beads. With the usage of insulated metal beads, the heavily contaminated slurry oil can be filtered into a low solid content composition clean oil. More than 90% removal efficiency can be achieved at a very low DC input voltage.

Other embodiments of the invention are contemplated in view of the foregoing.

In an alternative embodiment, the insulated metal beads may be substituted with beads constructed of a semiconductor material or with beads having a semiconductor core surrounded by an insulating film. The semiconductor material may be doped accordingly to produce a desired electric field characteristic suitable for the filtering operation at hand.

In another alternative embodiment, some of all of the insulated metal beads may be substituted with insulated beads having a ferromagnetic core, thus further altering the non-uniformity of the electric field being applied.

In yet another embodiment, the electrodes are energized at selected intervals with AC power, DC power or a combination of AC and DC power.

While the foregoing embodiments have been described with applicability to use with an oil medium, other mediums are contemplated for which the foregoing may apply. For instance, water, blood or any other liquid medium, may be substituted for oil, for which dielectric particles may become subject to DEP forces as a result of the application of non-uniform electric field.

Although the invention has been described in detail herein with reference to preferred embodiments and certain described alternatives, it is to be understood that this description is by way of example only, and it is not to be construed in a limiting sense. It is to be further understood that numerous changes in the details of the embodiments of the invention, and additional embodiments of the invention, will be apparent to, and may be made by, persons of ordinary skill in the art having reference to this description. It is contemplated that all such changes and additional embodiments are within the spirit and true scope of the invention as claimed below.

1. An electric solid-liquid separator comprising:
a separator vessel, adapted to receive a fluid for passage therethrough;
means for generating a non-uniform electric field, between distal points within the separator vessel, sufficient to generate DEP forces within the separator vessel; and
a plurality of beads arranged as a bead bed disposed within the separator vessel, each bead, from a subset of the plurality of beads, including a metal core, said plurality of beads presenting within the vessel, a surface medium surrounding the metal core having a permittivity which is higher with the beads than without.

2. The electric solid-liquid separator of claim 1 wherein each bead of the subset of the plurality of beads, including a metal core, includes an electrically-insulated surface surrounding the metal core.

3. The electric solid-liquid separator of claim 2, wherein the electrically-insulated surface is a coating comprised of an insulation material selected from the group consisting of PTFE plastic, ceramic and a combination thereof.

4. The electric solid-liquid separator of claim 2 wherein the plurality of beads are comprised of beads having two or more different diameters, each diameter being measured from a line segment between two points on a bead outer surface through a bead center.

5. The electric solid-liquid separator of claim 4 further including a second subset of the plurality of beads, wherein each bead from the second subset includes a core consisting of material selected from a non-metal material, a semiconductor material, a ferromagnetic material and a combination thereof.

6. The electric solid-liquid separator of claim 1 further comprising a bead bed including the plurality of beads wherein the means for generating an electric field includes an electrode, within the vessel, which passes through the bead bed, the vessel being connected to ground and the plurality of beads being packed around the electrode.

7. The electric solid-liquid separator as recited in claim 1 wherein said means for generating a non-uniform electric field includes one or more electrodes having a first polarity and electrically connected to a power source and one or more grounds at a second polarity.

8. The electric separator of claim 1 wherein the vessel is cylindrical having a fluid ingress and a fluid egress at opposite ends.

9. The electric separator of claim 8 further comprising an inlet manifold disk between the fluid ingress port and the bead bed, and an outlet manifold disk between the bead bed and the fluid egress.

10. The electric separator of claim 9 wherein the inlet manifold disk and outlet manifold disk are made from a material selected from the group consisting of ceramic PTPB and a combination thereof.

11. The electric separator of claim 1 further comprising a pre-filter at the fluid ingress port to filter particles before fluid enters the vessel.

12. A method of solid-liquid separation comprising passing liquid with solid contaminants, under an electric or electromagnetic field, through a bead bed, the bead bed including a plurality of beads, each bead from the plurality of beads including a metal core, the plurality of beads together with the liquid forming a medium having a permittivity which is higher with the beads than without.

13. An electric separator comprising:
a. first electrode
b. a second electrode
c. an electric field generator being operable to generate, between the first and second electrodes, a non-uniform electric field, sufficient to generate DEP forces; and
d. a plurality of beads, positioned between the first and second electrodes, each bead, from a subset of the plurality of beads, having a metallic core, said plurality of beads presenting a medium having a permittivity which is higher with the plurality of beads than without.

14. A method of using an electric separator in conjunction with a separation cycle comprising the steps of:
a. powering an electrode to create a non-uniform electromagnetic field within a vessel such that the electrode and vessel have an opposite polarity within the electromagnetic field, wherein a plurality of channels are formed, within the vessel, among a plurality of metallic-cored beads positioned around the electrode;
b. introducing fluid, having solid particles therein, into the vessel at an ingress end to facilitate the flow of the fluid through the plurality of channels, a clarified fluid resulting from the solid particles within the fluid being retained against metallic-cored beads, from the plurality of beads, which have been polarized by the electromagnetic field; and
c. vacating the clarified fluid from the vessel through an egress end.

15. The method of claim 14, wherein the channels are spider reticular channels.

16. The method of claim 14, wherein the particles are retained against points of contact between the beads.

17. The method of claim 14 wherein the metallic-cored beads are insulated metal beads having an electrically-insulating outer surface surrounding a metal core.

18. The method of claim 17, wherein the insulated metal beads are anodized aluminum beads.

19. The method of claim 14, the electrode is powered using alternating current or direct current.

20. The method of claim 17 wherein the insulated metal beads are coated with insulation materials selected from the group consisting of PTFE plastic, ceramic and a combination thereof.

21. The method of claim 14 further comprising a cleaning cycle comprising:
a. powering down the electrode within the vessel to cease generation of the electromagnetic field;
b. introducing a cleaning fluid into the vessel; and
c. causing the cleaning fluid to pass through channels, among the plurality of channels, and push the solid particles out of the channels, wherein the solid particles are no longer retained against the beads due to the absence of the electromagnetic field.

22. The method of claim 21, further comprising the step of pushing pressurized gas through the vessel to push out the cleaning fluid.
